(19) United States
(12) Patent Application Publication
(10) Pub. No.: US 2008/0183572 A1
(43) Pub. Date: Jul. 31, 2008

(54) METHODS AND APPARATUS TO CONVEY SALES INFORMATION TO CUSTOMERS USING FIELD SERVICE PERSONNEL

(76) Inventors: Bennett Seyer, Ballwin, MO (US); Wanda D. Payton-Black, Guthrie, OK (US); Jijoe Joseph Vurghese, San Ramon, CA (US); Sneha Krishnapillai, O'Fallon, MO (US); William J. Morgan, Rowlett, TX (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/669,507

(22) Filed: Jan. 31, 2007

(51) Int. Cl. G06Q 30/00; G06Q 99/00

(52) U.S. Cl. 705/14; 705/1

(57) ABSTRACT

Methods and apparatus to convey information to customers using field service personnel are described. An example method obtains information associated with a customer service call for a customer prior to completion of the customer service call and automatically generates information associated with at least one of a product or a service not currently used by the customer based on the information associated with the customer. The example method also sends the generated information via a wireless communication medium to a portable electronic device to be accessed by a service person associated with the customer service call.

### FIELD OF THE DISCLOSURE

This disclosure relates generally to the generation of sales referrals and, more particularly, to methods and apparatus to convey sales information to customers using field service personnel.

### BACKGROUND

Expanding the revenue of a company is difficult when focusing on existing customers. For example, telecommunications companies or providers often find it difficult to make additional sales to a given customer once a particular product and/or service has been provided to a customer. In an effort to increase such additional sales, sales personnel typically follow-up with customers suggesting additional products or services. In some cases, the sales personnel may construct and/or use marketing profiles based on customer information for particular clients. The sales representatives may then use the marketing profiles to identify additional products and/or services that may be of particular benefit to the customers.

Occasionally, field service personnel or technicians employed by a telecommunications company or provider, in the course of providing service to a customer; generate a sales referral or lead. For example, during a service call to a customer location, a field service technician may mention other products and/or services offered by the technician's employer that may be of interest to the customer. As a result of this interaction with the customer, the customer may contact a sales representative of the technician's employer (i.e., the telecommunications provider) to obtain more information about and/or purchase the products and/or services discussed. In this manner, a service person can generate a sales referral that could result in the sale of additional products and/or services to the customer. However, field service personnel typically do not have access to tools or systems that facilitate the generation of such referrals. Instead, field service personnel are typically allowed to generate such sales referrals in an independent and ad hoc manner.

### BRIEF DESCRIPTION OF THE DRAWINGS

FIG. 1 is a schematic block diagram of an example system for conveying sales information to customers using field service personnel.

FIG. 2 is a flowchart representative of an example method of generating product and/or service information and conveying such information to field service personnel.

FIG. 3 is a flowchart representative of an example method of conveying the product and/or service information generated as shown in the example of FIG. 2 to a customer during execution of a service call.

FIG. 4 is a flowchart representative of an example method of crediting a sales referral to a service person that has conveyed the product and/or service information as shown in the example of FIG. 3.

FIG. 5 is a block diagram of an example processor system that may be used to implement the example apparatus and methods described herein.

### DETAILED DESCRIPTION

The example methods and apparatus described herein can be used to enable field service personnel to provide targeted sales information to customers in the course of executing or completing service calls to those customers. More specifically, in the examples described herein, information associated with customer service calls to be executed is collected in a central location such as, for example, a service call processing center. The service call information may be processed by a service operator, a service call processing engine, and/or by any other suitable processing unit or system to schedule future services calls. For example, the operator and/or service call processing engine may schedule the dates and times at which the service calls are to be executed and may also assign execution of service calls to one or more field service personnel (e.g., technicians). The service call information may then be processed to associate customer-related information such as, for example, a customer phone number, customer proprietary network information, current product(s) and/or services used by the customer, demographic information, etc. with each of the service calls.

The service call information, including the associated customer-related information, may then be processed by a sales processing engine or system that uses the customer-related information to identify products and/or services that may be of interest to the customers corresponding to the service calls to be executed. In particular, for each service call and corresponding customer, the sales processing engine may identify products and/or services that are not currently being used by the customer and, based on other customer-related information, may be of interest to the customer. In other words, the sales processing engine can generate recommendations, promotions, etc. for products and/or services that may be of particular interest to customers on a customer-by-customer basis. Such products and/or services may be associated with a likely or an actual need or interest of a customer, a geographic location of the customer (e.g., products and/or services that are popular in the geographic region in which the customer is located (e.g., lives), or any other customer-related parameters.

The sales processing engine may generate the product and/or service information prior to dispatch of the service calls so that upon dispatch each service person receives the product and/or service information via, for example, a portable, handheld electronic tool or device (e.g., a personal data assistant type device). The device will display service call information and the information associated with products and/or services that may be of interest as generated by the sales processing engine for each of the customers corresponding to the service calls.

A communications server or other communications interface may be used to convey (e.g., via a wireless communication network) service call information and related product/service information generated by the sales processing engine to each of the portable electronic devices associated with the service personnel. Thus, when a service person is dispatched to execute a service call, their portable electronic device or tool can be accessed by the service person to automatically provide (e.g., via a display) the information associated with products and/or services that may be of particular interest to the customer. As a result, the service person can more effectively generate a sales referral because targeted sales information associated with products and/or services that are not currently used by customers can be presented to customers by the service person in the course of completing a service call.

As used herein, a service call includes activities and/or information relating to processing and/or responding to a request for service by a customer. A service call may arise, for example, when a customer calls a service call center and requests service relating to product and/or service that the customer is currently using. Execution or completion of a service call typically involves a service person or technician contacting the customer, either via a service visit to a customer location at which service is needed or remotely via, for example, telephone, electronic mail, facsimile, or any other manner of communication.

During a service call, portable electronic devices used by field service personnel may be provided with a printer or other similar device to generate a printed article (i.e., a hardcopy) of the product and/or service information to be provided to the customer. The hardcopy may further include a promotional code or the like, which can be provided to a sales center if/when the customer buys the product and/or service. In this manner, the referral effectiveness of the example apparatus and methods described herein can be measured and/or the service person providing the product and/or service information to the customer can be credited with the sales referral.

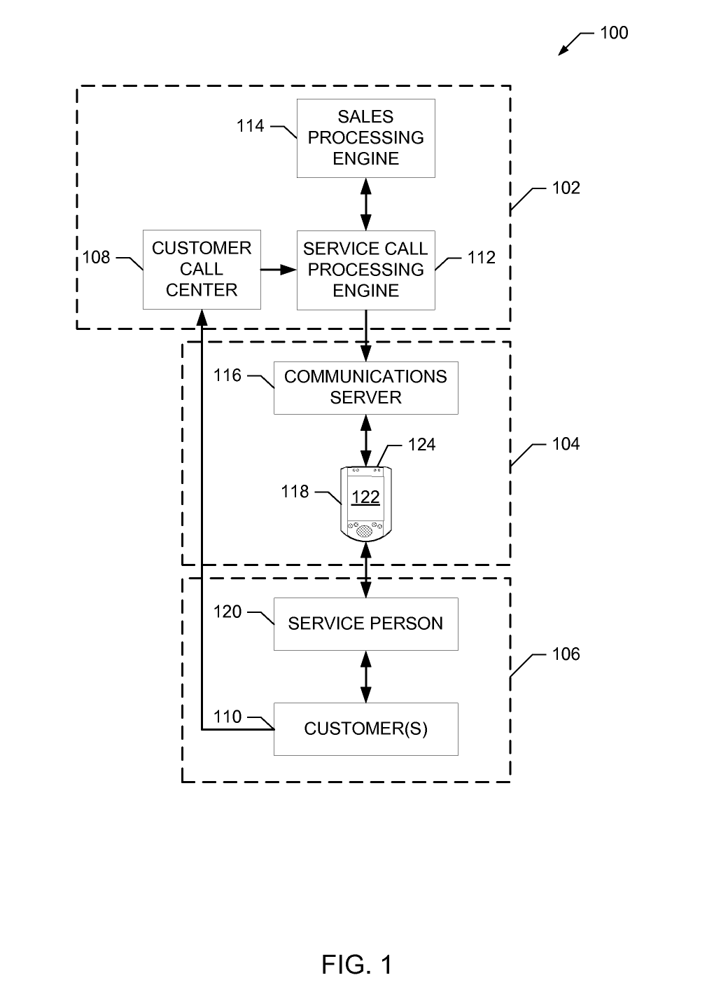

Now turning in detail to FIG. 1, a schematic block diagram of an example system 100 for conveying sales information to customers using field personnel is provided. In general, the example system 100 enables field service personnel (e.g., field service technicians) to more effectively communicate information relating to products and/or services that may be of interest to customers in the course of executing service calls. In this manner, the example system 100 provides a more effective manner of generating sales referrals than known ad hoc methods.

As shown in FIG. 1, the example system 100 includes a service call processing portion or center 102, a communications portion 104, and a service call execution portion 106. The service call processing portion 102 includes a customer call center 108 to receive service requests from one or more customers 110. The customer call center 108 may be implemented using manual and/or automated equipment to process the calls (e.g., telephone calls) made by customers in need of service. Thus, the customer call center 108 may include phone operators that collect service request information from the customers 110. For example, operators may request information such as customer phone number, account number, etc. Alternatively or additionally, the customer call center 108 may utilize speech recognition systems to automatically process customer calls requesting service. In any case, the customer call center 108 may generate, maintain (e.g., in a database or other memory structure), and/or update information profiles for the customers 110.

The customer call center 108 is communicatively coupled to a service call processing engine 112 that can also obtain customer-related information for each of the service calls received and logged by the customer call center 108. Such customer-related information can include customer phone numbers, customer proprietary network information, products and/or services currently used by the customers, demographic information, actual or likely needs or interests of customers, the geographic locations of the customers, etc.

The service call processing engine 112 also processes the service call request information received from the customer call center 108 to generate a service call schedule (e.g., service call dates and times) and assign execution of the service calls to one or more service personnel. Additionally, the customer-related information may be stored in a database (not shown) that is accessible via the service call processing engine 112 and which may also be accessible by a sales processing engine 114 discussed in greater detail below.

The service call processing engine 112 obtains the customer-related information associated with each of the service call requests that it processes and passes the service call information as well as the customer-related information corresponding to each of the service calls to the sales processing engine 114. The sales processing engine 114 then processes this information to automatically generate, for each service call, information associated with at least one of a product or a service not currently used by the customer corresponding to the service call based on the customer-related information for that customer.

The sales processing engine 114 may be implemented using a software tool known as the Epiphany Real-Time Engine, which includes a rule engine configured to facilitate the selection of products and/or services suitable for each of the customers 110. The sales processing engine 114 may also be used and/or accessed by sale representatives, who may provide product and/or service information, rule information for identifying products and/or services that may be of interest to customers based on customer-related information or other parameters, promotional information, and/or any other sales-related information.

The service call processing engine 112 may dispatch service calls by sending service call information to a communications interface or server 116. The communications server 116 may enable communications via a wireless network and/or any other hard wired network or combination of wireless and hardwired networks to one or more portable electronic devices (e.g., handheld portable electronic devices 118), each of which is associated with a particular service person (e.g., service person 120). Thus, when a service call is dispatched to the service person 120, the service person 120 receives service call information (e.g., customer name, phone numbers, address, nature of the service call, etc.) via their portable electronic device 11 8. Additionally, the service person 120 receives information associated with products and/or services that may be of interest to that customer as generated by the sales processing engine 114. Such products and/or services are preferably not currently used by the customer 110 and may be associated with a likely interest or need of the customer 110, a demographic characteristic of the customer 110, a geographic location of the customer 110, a product promotional campaign, etc.

Thus, in the course of executing a service call on which the service person 120 has been dispatched, the service person 120 may access their portable electronic device 118 (e.g., via a display 122) to receive the product and/or service information that may be of particular interest to the customer 110. The service person 120 may then convey some or all of the product and/or service information to the customer 110 to attempt to generate a sales referral (i.e., a subsequent inquiry and/or purchase relating to an additional product and/or service by the customer 110 as a result of the conveying of the product and/or service information). The portable electronic device 118 may also include a printer or other similar device 124 to generate a printed article (e.g., a hardcopy) containing some or all of the information associated with the products and/or services that may be of interest to the customer 110. The printed article may also include a promotional or other code that can be used to credit the service person with a sales referral, to determine the effectiveness of the system 100, etc.

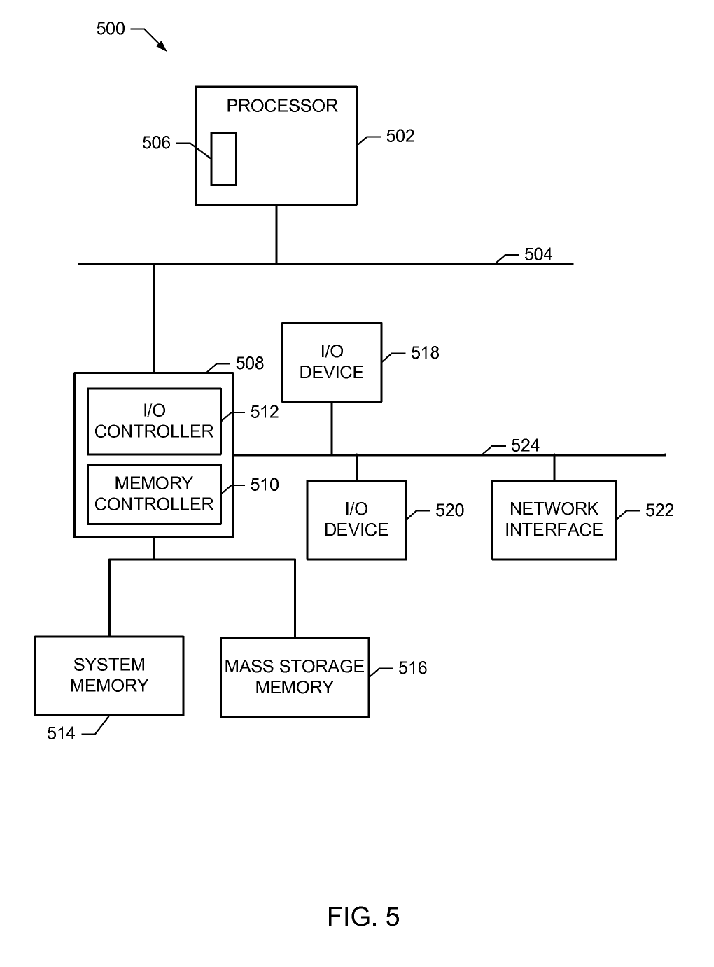

In some implementations, the communications server 116 may communicate with the portable electronic device 118 using object-based constructs such as, for example, a JAVA object format and/or may employ one or more application programming interfaces (APIs), which are well known software constructs for exchanging data between software modules. Similarly, the various blocks of the service call center 102 may interoperate via one or more APIs. For example, the sales processing engine 114 and the service call processing engine 112 may communicate via an API. Still further, some or all of the blocks of the service call center 102 and the communications portion 104 can be implemented using one processor system, multiple or separate processor systems or processors, etc. One such example processor system 500 is provided in connection with FIG. 5, which is described in detail below.

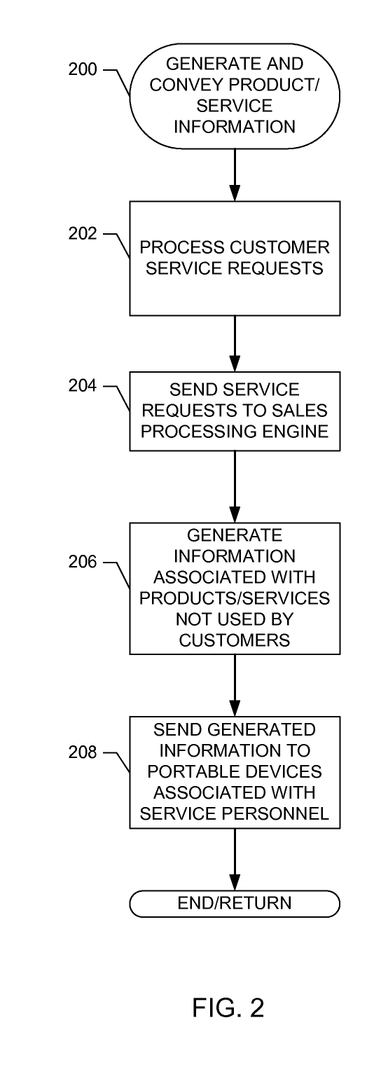

The example flowcharts depicted in FIGS. 2-4 and described below represent methods or processes that may be implemented using machine readable instructions comprising a program for execution by a processor (e.g., the processor 502 shown in the example processor system 500 of FIG. 5). The program may be embodied in software stored on a tangible medium such as a CD-ROM, a floppy disk, a hard drive, a digital versatile disk (DVD), or a memory associated with the processor 502 and/or embodied in firmware and/or dedicated hardware in a well-known manner. Further, although the example programs are described with reference to the flowcharts illustrated in FIGS. 2-4, persons of ordinary skill in the art will readily appreciate that many other methods of implementing the example methods may alternatively be used. For example, the order of execution of the blocks may be changed, and/or some of the blocks described may be changed, eliminated, or combined. Further, some or all of the blocks may be performed manually.

FIG. 2 is a flowchart representative of an example method 200 of generating product and/or service information and conveying such information to field service personnel. Initially, the example method 200 processes customer service requests (e.g., via the customer call center 108 and the service call processing engine 112 of FIG. 1) (block 202). The processed service requests are then sent or conveyed to a sales processing engine (e.g., the sales processing engine 114 of FIG. 1) (block 204). The service requests may be conveyed using data constructs such as JAVA objects via one or more APIs. The example method 200 then generates information (e.g., via the sales processing engine 114) associated with products and/or services not currently used by the customers associated with the service call requests (block 206). The information generated at block 206 may then be sent (e.g., using JAVA objects or files via the communications server 116) to portable devices (e.g., the portable device 118) associated with the service personnel (e.g., the service person 120) (block 208). The information generated at block 206 is generated prior to initiation of the service call(s) and the information is sent to the portable devices at block 208 prior to completion of the service call. In some examples, the information sent at block 208 may be sent prior to dispatch of the service person on the service call.

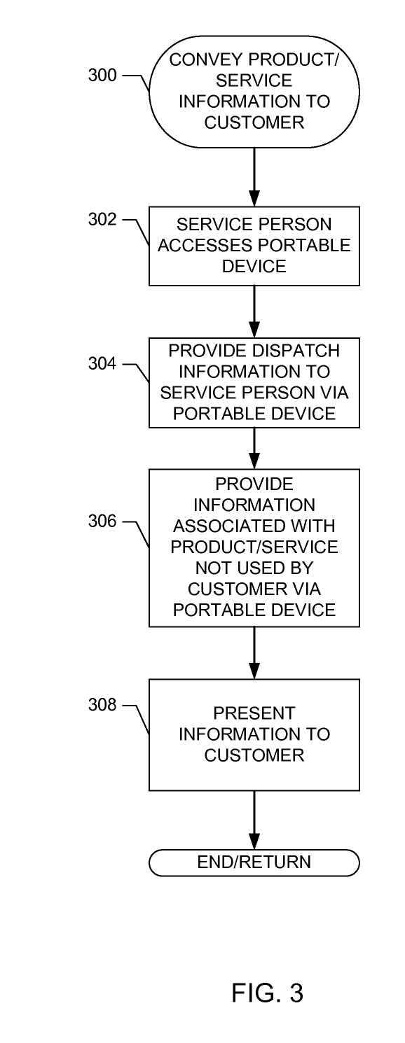

FIG. 3 is a flowchart representative of an example method 300 of conveying the product and/or service information generated as shown in the example of FIG. 2 to a customer during execution of a service call. Initially, a service person (e.g., the service person 120 of FIG. 1) accesses their portable electronic device (e.g., the portable device 118 of FIG. 1) (block 302). For example, the service person may activate a display (e.g. the display 122 of FIG. 1) of their portable device to view service call related information therein. Such service information may include repair guidelines, procedures, or any other information related to the performance of service. The example method 300 then provides dispatch information to the service person. For example, service call date and time, customer name(s), customer address, service issue or problem, etc. may be provided via the portable electronic device (block 304).

The example method 300 then provides information associated with products and/or services not currently used by the customer that may be of interest to the customer (block 306). The information provided at block 306 may be displayed to the service person via the portable electronic device (e.g., via the display 122). Then, some or all of the information presented to the service person at block 308 may be presented to the customer (block 308). The information presented at block 308 may be presented verbally by the service person in a manner that the service person believes to be most effective under the circumstances. For example, the service person may elect to present only a subset of the information presented at block 306 based on information gathered in the course of interacting with the customer during the service call. Some or all of the information presented by the service person may be provided in the form of a printed article (e.g., a hardcopy), which may also contain contact information and a promotional code or other code to enable the crediting of a sales referral to the service person and/or to determine the effectiveness of the system 100 (FIG. 1).

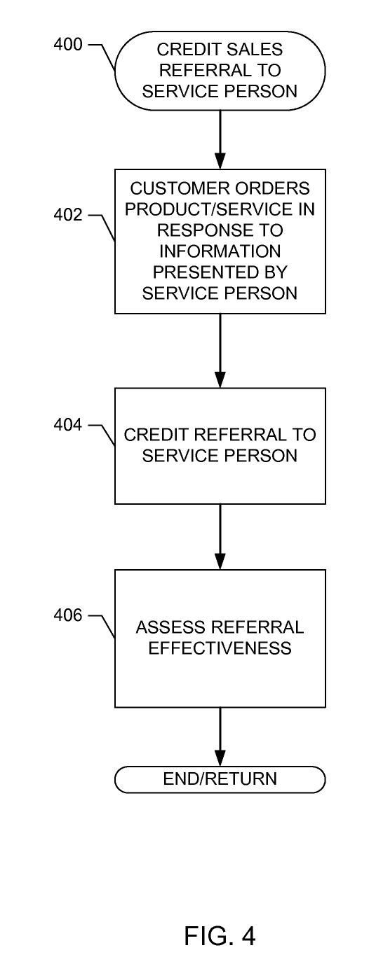

FIG. 4 is a flowchart representative of an example method 400 of crediting a sales referral to a service person that has conveyed the product and/or service information as shown in the example of FIG. 3. Initially, a customer orders a product and/or service in response to information presented by a service person (e.g., presented at block 308 of FIG. 3) (block 402). Once the order is placed, the database containing customer information is updated to reflect the change in the products and/or services currently used by the customer. This enables maintenance of accurate records of customer profiles. The service person is then credited with a sales referral (block 404) and, optionally, the method 400 assesses the effectiveness of the system 100 (FIG. 1) in generating referrals and/or generating revenue (block 406).

FIG. 5 is a block diagram of an example processor system 500 that may be used to implement the example apparatus and methods described herein. As shown in FIG. 5, the processor system 500 includes a processor 502 that is coupled to an interconnection bus 504. The processor 502 includes a register set or register space 506, which is depicted in FIG. 5 as being entirely on-chip, but which could alternatively be located entirely or partially off-chip and directly coupled to the processor 502 via dedicated electrical connections and/or via the interconnection bus 504. The processor 502 may be any suitable processor, processing unit or microprocessor. Although not shown in FIG. 5, the system 500 may be a multi-processor system and, thus, may include one or more additional processors that are identical or similar to the processor 502 and that are communicatively coupled to the interconnection bus 504.

The processor 502 of FIG. 5 is coupled to a chipset 508, which includes a memory controller 510 and an input/output (I/O) controller 512. As is well known, a chipset typically provides I/O and memory management functions as well as a plurality of general purpose and/or special purpose registers, timers, etc. that are accessible or used by one or more processors coupled to the chipset 508. The memory controller 510 performs functions that enable the processor 502 (or processors if there are multiple processors) to access a system memory 514 and a mass storage memory 516.

The system memory 514 may include any desired type of volatile and/or non-volatile memory such as, for example, static random access memory (SRAM), dynamic random access memory (DRAM), flash memory, read-only memory (ROM), etc. The mass storage memory 516 may include any desired type of mass storage device including hard disk drives, optical drives, tape storage devices, etc.

The I/O controller 512 performs functions that enable the processor 502 to communicate with peripheral input/output (I/O) devices 518 and 520 and a network interface 522 via an I/O bus 524. The I/O devices 518 and 520 may be any desired type of I/O device such as, for example, a keyboard, a video display or monitor, a mouse, etc. The network interface 522 may be, for example, an Ethernet device, an asynchronous transfer mode (ATM) device, an 802.11 device, a DSL modem, a cable modem, a cellular modem, etc. that enables the processor system 500 to communicate with another processor system.

While the memory controller 510 and the I/O controller 512 are depicted in FIG. 5 as separate functional blocks within the chipset 508, the functions performed by these blocks may be integrated within a single semiconductor circuit or may be implemented using two or more separate integrated circuits.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

To the extent the above specification describes example components and functions with reference to particular standards and protocols, it is understood that the scope of this patent is not limited to such standards and protocols. For instance, each of the standards for Internet and other packet switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general purpose. Accordingly, replacement standards and protocols having the same general purpose are equivalents to the standards/protocols mentioned herein, and contemplated by this patent, are intended to be included within the scope of the accompanying claims.

This patent contemplates examples wherein a device is associated with one or more machine readable mediums containing instructions, or receives and executes instructions from a propagated signal so that, for example, when connected to a network environment, the device can send or receive voice, video or data, and communicate over the network using the instructions. Such a device can be implemented by any electronic device that provides voice, video and/or data communication, such as a telephone, a cordless telephone, a mobile phone, a cellular telephone, a Personal Digital Assistant (PDA), a set-top box, a computer, and/or a server.

Additionally, although this patent discloses example software or firmware executed on hardware and/or stored in a memory, it should be noted that such software or firmware is merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example methods and articles of manufacture, persons of ordinary skill in the art will readily appreciate that the examples are not the only way to implement such methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed:

1. A method comprising:
obtaining information associated with a customer service call for a customer prior to completion of the customer service call;
automatically generating information associated with at least one of a product or a service not currently used by the customer based on the information associated with the customer; and
sending the generated information via a wireless communication medium to a portable electronic device to be accessed by a service person associated with the customer service call.

2. The method as defined in claim 1, wherein obtaining the information associated with the customer comprises obtaining the information associated with the customer service call during a call from the customer to a customer call center.

3. The method as defined in claim 2, wherein obtaining the information associated with the customer during the call from the customer to the customer call center schedules the service person for a service visit to the customer.

4. The method as defined in claim 1, wherein obtaining the information associated with the customer service call comprises obtaining information corresponding to the customer.

5. The method as defined in claim 4, wherein obtaining the information corresponding to the customer comprises obtaining at least one of a phone number, customer proprietary network information, a product used by the customer, or a service used by the customer.

6. The method as defined in claim 1, wherein automatically generating the information associated with the at least one of the product or the service not currently used by the customer based on the information associated with the customer comprises determining if the at least one of the product or the service is associated with at least one of an interest of the customer, a need of the customer, a geographic location of the customer, a promotion, or a product recommendation.

7. The method as defined in claim 1, wherein automatically generating the information associated with the at least one of the product or the service not currently used by the customer based on the information associated with the customer service call comprises conveying the information associated with the customer service call to a sales processing engine to generate the information associated with the at least one of the product or the service not currently used by the customer.

8. The method as defined in claim 7, wherein conveying the information associated with the customer service call to the sales processing engine comprises conveying the information associated with the customer service call via an application programming interface.

9. The method as defined in claim 1, further comprising presenting by the service person to the customer at least some of the generated information.

10. The method as defined in claim 9, wherein presenting by the service person to the customer the at least some of the generated information comprises providing a printed article containing the at least some of the generated information.

11. The method as defined in claim 9, further comprising crediting the service technician with a sales referral in response to receiving an inquiry from the customer in response to the at least some of the generated information.

12. A method comprising:
receiving dispatch information associated with a customer service call via a portable electronic device to be accessed by a service person; and
receiving via the portable electronic device, information associated with at least one of a product or a service not currently used by a customer based on information associated with the customer.

13. The method as defined in claim 12, wherein receiving the dispatch information associated with the customer service call comprises receiving the dispatch information prior to the service person initiating a service visit to the customer.

14. The method as defined in claim 12, wherein the at least one of the product or the service not currently used by the customer is associated with at least one of an interest of the customer, a need of the customer, a geographic location of the customer, a promotion, or a product recommendation.

15. The method as defined in claim 12, wherein the portable electronic device displays at least some of the information associated with the at least one of a product or a service not currently used by the customer to the customer prior to completion of a service visit to the customer.

16. The method as defined in claim 12, further comprising conveying by the service person at least some of the information associated with the at least one of the product or the service not currently used by the customer by providing a printed article containing the at least some of the information to the customer.

17. A portable electronic device comprising:
a memory;
a processor coupled to the memory, the processor to receive dispatch information associated with a customer service call and to receive information associated with at least one of a product or a service not currently used by a customer based on information associated with the customer; and
a display to present at least some of the information associated with the at least one of a product or a service not currently used by the customer to a service person.

18. The portable electronic device as defined in claim 17, wherein the portable electronic device is to receive the dispatch information associated with the customer service call prior to the service person initiating a service visit to the customer.

19. The portable electronic device as defined in claim 17, wherein the at least one of the product or the service not currently used by the customer is associated with at least one of an interest of the customer, a need of the customer, a geographic location of the customer, a promotion, or a product recommendation.

20. The portable electronic device as defined in claim 17, wherein the portable electronic device is to present the at least some of the information associated with the at least one of the product or service not currently used by the customer via a printed article.

21. The portable electronic device as defined in claim 17, wherein the portable electronic device is to receive information via a wireless communication system.
